(19) United States
(12) Patent Application Publication
(10) Pub. No.: US 2011/0239306 A1
(43) Pub. Date: Sep. 29, 2011

(54) DATA LEAK PROTECTION APPLICATION

(75) Inventors: Yossi Avni, Caesarea (IL); Eytan Suchard, Kiryat Bialik (IL)

(73) Assignee: APPLIED NEURAL TECHNOLOGIES LIMITED, Tortola (VG)

(21) Appl. No.: 13/060,540

(22) PCT Filed: Aug. 27, 2009
(86) PCT No.: PCT/GB2009/051073

§ 371 Date: May 27, 2011

(30) Foreign Application Priority Data
Aug. 27, 2008 (GB) 0815587.1

(51) Int. Cl. G06F 21/00

(52) U.S. Cl. 726/26

(57) ABSTRACT

A data leak protection method for managing user interaction with a computing device, the computing device comprising a kernel mode of operation and a user mode of operation, the method comprising: monitoring the kernel mode of the computing device in order to detect user-initiated events; determining whether a given user-initiated event has a forbidden status or an allowed status; performing an action in dependence on the status of the given user-initiated event.

### FIELD OF INVENTION

The present invention relates to a data leak protection application. In particular, the present invention is a data leak protection software method (or corresponding system or application) which monitors usage of a computing device and which is capable of enforcing a security policy on the computing device (be it a PC, laptop or other processing means). The invention may be operated on a stand-alone machine or within a computer network.

### BACKGROUND TO THE INVENTION

In any modern operating system, the CPU (central processing unit) is actually spending time in two distinct modes: kernel mode and user mode,

In Kernel mode (also referred to as system mode or supervisor mode), the executing code has complete and unrestricted access to the underlying hardware. It can execute any CPU instruction and reference any memory address. Kernel mode is generally reserved for the lowest-level, most trusted functions of the operating system. Crashes in kernel mode are catastrophic and will halt the entire computer.

In User mode, executing code has no ability to directly access hardware or reference memory. Code running in user mode must delegate to system APIs (application programming interfaces) to access hardware or memory. Due to the protection afforded by this sort of isolation, crashes in user mode are recoverable. Most of the code running on a computer will execute in user mode. User mode is a non-privileged mode for user programs.

When the CPU is in kernel mode, it is assumed to be executing trusted software, and thus it can execute any instructions and reference any memory addresses (i.e., locations in memory). The kernel (which is the core of the operating system and has complete control over everything that occurs in the system) is trusted software, but all other programs are considered untrusted software. Thus, all user mode software must request use of the kernel by means of a system call in order to perform privileged instructions, such as process creation or input/output operations.

A system call is a request to the kernel in a Unix-like operating system by an active process for a service performed by the kernel. A process is an executing instance of a program. An active process is a process that is currently advancing in the CPU (while other processes are waiting in memory for their turns to use the CPU). Input/output (I/O) is any program, operation or device that transfers data to or from the CPU and to or from a peripheral device (such as disk drives, keyboards, mice and printers).

An interrupt is a signal to the operating system that an event has occurred, and it results in a change in the sequence of instructions that is executed by the CPU. In the case of a hardware interrupt, the signal originates from a hardware device such as a keyboard (i.e., when a user presses a key), mouse or system clock (a circuit that generates pulses at precise intervals that are used to coordinate the computer's activities). A software interrupt is an interrupt that originates in software, and it is usually triggered by a program in user mode. The standard procedure to change from user mode to kernel mode is to call the software interrupt 0×80. An exception is an unusual condition, for example an invalid instruction in a program.

All processes begin execution in user mode, and they switch to kernel mode only when obtaining a service provided by the kernel. This change in mode is termed a mode switch, not to be confused with a context switch (although it sometimes is), which is the switching of the CPU from one process to another.

When a user process runs a portion of the kernel code via a system call, the process temporarily becomes a kernel process and is in kernel mode. While in kernel mode, the process will have root (i.e., administrative) privileges and access to key system resources. The entire kernel, which is not a process but a controller of processes, executes only in kernel mode. When the kernel has satisfied the request by a process, it returns the process to user mode.

Some CPUs, including the nearly ubiquitous x86-compatible (i.e., Intel-compatible) processors, are designed to accommodate more than two execution modes. However, all standard kernels in Unix-like operating systems utilize only kernel mode and user mode.

Some operating systems, such as MS-DOS (the predecessor to the Microsoft Windows operating systems) do not have a distinct kernel mode; rather, they allow user programs to interact directly with the hardware components. However, Unix-like operating systems use the dual mode mechanism to hide all of the low level details regarding the physical organization of the system from application programs launched by the user as a means of assuring system stability and security.

The Linux kernel Version 2.6 (which was introduced in late 2003) is preemptive. That is, a process running in kernel mode can be suspended in order to run a different process.

This can be an important benefit for real time applications (i.e., systems which must respond to external events nearly simultaneously).

Unix-like kernels are also reentrant, which means that several processes can be in kernel mode simultaneously. However, on a single-processor system, only one process, regardless of its mode, will be progressing in the CPU at any point in time, and the others will be temporarily blocked until their turns.

Most processors have at least two different modes. The x86-processors have four different modes divided into four different rings (see FIG. 1). Programs that run in Ring 0 (kernel) can do anything with the system, and code that runs in Ring 3 (user) should be able to fail at any time without impact to the rest of the computer system. Ring 1 and Ring 2 are rarely used, but could be configured with different levels of access.

It can therefore be appreciated that unauthorised access of the kernel mode of a computer can cause serious problems. Existing methods/systems for preventing unauthorised access attempts include: hardware based firewalls which configure a programmable router to block ports; software based firewalls where the operating system defines rules to block ports; software based firewalls which control packets sent and received by permitted ports (In the Windows environment this software based method is achieved using Filter-Hook which is a kernel mode driver. The driver sends the address of a Callback function via IRP (I/O Request Packet) to an existing IP Filter Driver. Any IP packet will be sent to the Callback function. These packets are then processed and their content can be monitored by advanced data mining tools in order to detect malicious requests). It is noted that Filter-Hook drivers were first introduced by Microsoft in Windows 2000 DDK (Driver Development Kit).

It is noted that the above methods/systems protect against external attempts to access a computer or computer network. However, it is noted that computers and computer networks may also be compromised by authorised users deliberately or accidentally copy, sending or printing data once logged into the computer or network. Such activities may be referred to a data leak events and it is an object of the present invention to provide a mechanism for mitigating against such events occurring.

### SUMMARY OF INVENTION

According to a first aspect of the present invention there is provided a data leak protection method for managing user interaction with a computing device, the computing device comprising a kernel mode of operation and a user mode of operation, the method comprising: monitoring the kernel mode of the computing device in order to detect user-initiated events; determining whether a given user-initiated event has a forbidden status or an allowed status; performing an action in dependence on the status of the given user-initiated event.

The present invention operates essentially as an “inside” firewall, i.e. it protects a computing device, computer or a wide-area-network on which the computer is connected from data leakage or information theft. The present invention therefore provides a data leak protection method (further aspects of the present invention described below relate to a corresponding data leak protection system, data leak protection application, data leak protection computer program etc.)

It is also noted that the present invention may be applied to any suitable computing device, such as computers, servers, networks, PCs, laptops, “smartphones”, PDAs and any other processing means where data leakage is a potential issue. The term “computing device” should therefore be understood to encompass all such devices and processing means.

The present invention may be embodied as a software application which monitors computer usage and which can enforce an organization's security policy on each user's computer whether desktop or laptop or any other computing device. The invention operates by tracking the internal processes of computing devices and detecting forbidden events and activities in real-time. A number of examples of the use of the invention are discussed below in which a Listener Object (referred to below as the Enforcer Agent Events Listener Object or EAEL) receives messages from the operating system object (OSO) running in kernel mode of a computing device running a software application in accordance with an embodiment of the present invention. It is noted that the invention covers system setups in which the EAEL listens passively to message traffic within the computing device and also to setups where the OSO is managed to send messages to the EAEL in kernel mode.

It is further noted that the present invention may be operative to detect, alert, record and block unauthorised activities that occur.

The present invention may detect forbidden events in real-time using a sniffing mechanism. Operating system events may be detected and, derived from that, the invention may detect running applications events in real-time (including events associated with removable devices).

The present invention may be configured to alert an organization's security team in real-time on each high risk event as derived from a security policy. Forbidden activities may be initiated by the operating system and/or by third parties running software applications and/or by an authorized user using the user's credentials (SID—Security Token).

The present invention may be configured to report on any detected event transactions, to a central database. Such reporting would, if enabled, provide IT forensic services in real-time rather than recovering forensic information for future inspections. Furthermore, recorded event transaction may provide a clear picture about any security policy breach which is executed by the end-user or by third party applications using the user's credentials.

The present invention may be configured to block forbidden activities as derived from the enforced security policy and therefore, minimize the overall damage which can be caused by the forbidden activities

It is noted that in particular, the present invention may monitor and prevent the following events from occurring:
1) Data Leak Protection: A data leak event is where a user copies digital information from inside resources and pastes it to a forbidden application or to outside sites such as, Google Gmail web mail. The present invention may detect forbidden activity based on an enforced security policy. Detection may be immediate and in real time, and any activity may be reported to a security team. The present invention may also move to block such activities. It is noted that the “Pasting” action may include but not be limited to Clipboard Copy/Paste events and non clipboard Drag/Drop events.
2) PrintScreen Activities: In this case, inside information which is accessed and displayed on the end-user's screen may be copied as a digital image to an outside resource, device or web site. The present invention may be configured to detect all Print-Screen activities, report these activities to the security team and based on the organization security policy, it may block the attempt to paste sensitive information to third party applications and/or web mail.
3) Peripheral Devices: To avoid data leakage, many organizations restrict the usage of Disk-On-Key USB devices, including SD memory cards and any other removable memory/storage devices that are attached to peripheral devices. Unauthorized activities, such as copying confidential files to the removable storage device, can be exploited by inside users to steal inside information from the organization. The present invention may detect USB Disk-On-Key and other removable device insertions, alert the security team on these forbidden activities and, based on the organization security policy, may block the new volume drive by dismounting it. All such transactions may be recorded as forensic activity in a central database.
4) File Renaming: Another way to steal information from the inside is by renaming the original file with a dummy filename, for example, renaming a word document to “nothing.abc” filename which may be automatically construed by the O/S as a valueless file. The organization security policy can classify such an event of filename renaming as suspicious activity by sending security warnings. Any attempt to rename a file may be reported to the organization security team in real-time and has its pre-defined risk rank.
5) File Deletion: Deleting files, by the user or by a running application or by the operating system may be classified as a suspicious security event. In this case, the user's credentials are being used to delete these files. The present invention may be configured to report on these file deletion activities and the organization is responsible for any file recovery. In some cases, a limited, blocking file deletion set up, may be applicable. Most of the file deletion activities are performed automatically by the operating system and by third party applications. These activities may be monitored for forensic purposes as a background activity. It reflects the user activities while running specific applications and/or using the O/S working environment.
6) Confidential files system: The invention may track down files that are defined by the administrator as Confidential. The definitions may either be in an Active Directory on a server if the computing device is connected to Intranet or in local files if the computing device is offline. Confidential files should not be saved onto new file names but copies may be saved into other directories as long as the file name remains the same as the original one. In addition there may be rules that define certain directories in which file renaming, deletion and Save-As actions are allowed and other directories in which files renaming, deletion or Saved-As events are not allowed.
7) Task Scheduler supervision: The Task Scheduler can automatically run programs, commands and batch files. The invention may report these commands and allow predefined policy to determine whether to allow or deny task requests.
8) Console commands: Consoles enable the user to type commands. Such commands can be harmful. That is why the system hooks to console applications and monitors the typed commands. The present invention may deny console commands if they pose data loss risks. The XML or other syntax for command prohibition rules is the same for both console commands and for the Task Scheduler.
9) White list, black list and gray list applications: White list applications refer to applications that are granted free access to sensitive system resources. For example, a known Media Player may appear in the white list of full screen access. Granting device access to the entire screen can be just as harmful as allowing Print Screen when a confidential document is displayed. A black list contains program names, and/or hash code e.g. CRC, that are not allowed access to certain system resources. Gray scale applications are running programs that behave suspiciously, e.g. the sequence of calling different APIs (Application Programming Interface) and the frequency of calling certain API functions make these programs suspicious. Such programs may pose a threat to the confidentiality of data on the storage media. Gray scale applications are inferred by advanced classification tools, which include, Artificial Neural Networks, Decision Trees, Clustering & High Order Clustering, Support Vector Machines and others.

Further features according to the first aspect of the present invention are detailed below.

The data leak protection method may conveniently further comprise providing a data leak protection object in the user mode of the computing device. The data leak protection object in the user mode may be injected into every running application in the user mode and conveniently may be provided by injecting computer code into executable files [running services/running processes].

Conveniently, the monitoring step of the first aspect of the present invention may then comprise the data leak protection object listening to kernel mode message traffic. Alternatively, the monitoring step may comprise the data leak protection object receiving notifications from an operating system object in the kernel mode whenever a user-initiated event occurs. The data leak protection object may also indirectly monitor the kernel mode of the computing device by listening to user mode message traffic.

The data leak protection method may also conveniently further comprise a data leak protection agent in the kernel mode of the computing device. The monitoring step may then comprise the data leak protection agent intercepting a system call from a user mode application. Conveniently, the determining step may comprise the data leak protection agent checking with a kernel mode memory unit to determine if the system call relates to a forbidden status event.

The data leak protection agent in the kernel mode of the computing device may also be embodied within a device driver that hooks to system calls from user mode applications.

Preferably, the determining step comprises checking a monitored event against a database containing a data leak protection security policy.

Conveniently, a database comprising a list of allowed status and forbidden status events may be defined. Defining such a database may conveniently comprise defining what system calls given user mode applications are allowed to place.

Preferably the performing step comprises outputting a notification signal whenever a forbidden status event is detected. The performing step may also comprise storing a record of the detected event.

Preferably, the performing step comprises blocking the user-initiated event.

Preferably, the method according to the first aspect of the present invention further comprises watching for user-initiated attempts to circumvent data leak protection. In the event that a circumvention attempt is detected the computing device may either be shut down or rebooted.

Conveniently, the user-initiated events that the data leak protection method may monitor comprise one or more of the following: a copy/paste event (either a copy to system clipboard event or a drag/drop event that uses a different mechanism); a file renaming event; a file deletion event; mounting or dismounting a removable device; a printscreen event; a network change event; a console command event, a task scheduler event; a Save As event; a Print event.

Conveniently, the performing step may comprise raising a flag upon detection of a first event and monitoring for a given further user-initiated event, a further action being performed on detection of the given further event.

Preferably, where the monitored event is checked against a database or kernel mode memory unit, the determining step comprises checking name and a hash code of a program requiring access to system resources of the computing device.

According to a second aspect of the present invention there is provided a data leak protection system data leakage protection system for managing user interaction with a computing device, the computing device comprising a kernel mode of operation and a user mode of operation, the method comprising: monitoring means arranged to monitor the kernel mode of the computing device in order to detect user-initiated events; determining means arranged to determine whether a given user-initiated event has a forbidden status or an allowed status; performing means arranged to perform an action in dependence on the status of the given user-initiated event.

The invention extends to a carrier medium for carrying a computer readable code for controlling a computing device to carry out the method of the first aspect of the invention and a computer program embodied on a computer readable medium for controlling a computing device to manage user interaction with the computing device.

According to a third aspect of the present invention there is provided a computer program embodied on a computer readable medium for controlling a computing device to manage user interaction with the computing device, the computing device comprising a kernel mode of operation and a user mode of operation, wherein the computer program comprises: a code segment for monitoring the kernel mode of the computing device in order to detect user-initiated events; a code segment for determining whether a given user-initiated event has a forbidden status or an allowed status; a code segment for performing an action in dependence on the status of the given user-initiated event.

According to a fourth aspect of the present invention there is provided a data leakage protection application for managing user interaction with a computing device, the computing device comprising a kernel mode of operation and a user mode of operation, the method comprising: monitoring means arranged to monitor the kernel mode of the computing device in order to detect user-initiated events; determining means arranged to determine whether a given user-initiated event has a forbidden status or an allowed status; performing means arranged to perform an action in dependence on the status of the given user-initiated event.

The invention also extends to a network comprising a plurality of computing devices in communication with a server wherein each computing device comprises a data leak protection application according to the fourth aspect of the invention. Conveniently, a data leak protection policy is stored on the server. This policy may be periodically updated. Preferably, a computing device is arranged to download a current version of the data leak protection policy from the server each time it connects to the network, the current version of the data leak protection policy being used by the data leak protection application. In the event that a computing device is left permanently connected to the network then conveniently the computing device may either periodically update the data leak protection policy or be instructed to update the data leak protection policy (e.g. by the server or by a data security team).

### DESCRIPTION OF THE DRAWINGS

The present invention is described, by way of example only, with reference to the following figures, in which:

FIG. 1 shows a typical operating system privilege ring in which the zero ring has direct hardware access and ring 3 is the user-mode ring;

FIG. 2 represents a computer network having an online security policy managed by a Domain Active Directory server;

FIG. 3 illustrates a security policy in an offline mode;

FIGS. 4a and 4b illustrate a data leak protection method in accordance with embodiments of the present invention and a data leak protection system/application in accordance with embodiments of the present invention;

FIG. 5 illustrates the operation of an embodiment of the present invention in response to a first data leak event in which a removable device is detected;

FIG. 6 illustrates the operation of an embodiment of the present invention in response to a second data leak event in which a copy/paste event is detected;

FIG. 7 illustrates the operation of an embodiment of the present invention in response to a third data leak event in which a print-screen event is detected;

FIG. 8 illustrates the operation of an embodiment of the present invention in response to a fourth data leak event in which a full-screen access request is made;

FIG. 9 illustrates the operation of an embodiment of the present invention in response to a fifth data leak event in which a file deletion event is detected;

FIG. 10 illustrates the operation of an embodiment of the present invention in response to a sixth data leak event in which a file renaming event is detected;

FIG. 11 illustrates the operation of an embodiment of the present invention in response to a seventh data leak event in which a network change notification is detected;

FIG. 12 illustrates the operation of an embodiment of the present invention in response to an eighth data leak event in which console command events are detected;

FIG. 13 illustrates the operation of an embodiment of the present invention in response to a ninth data leak event in which a given task scheduler event is detected;

FIG. 14 illustrates the operation of an embodiment of the present invention in response to a tenth data leak event in which a Save-As event is called;

FIG. 15 illustrates the operation of an embodiment of the present invention in response to an eleventh data leak event in which print event is detected.

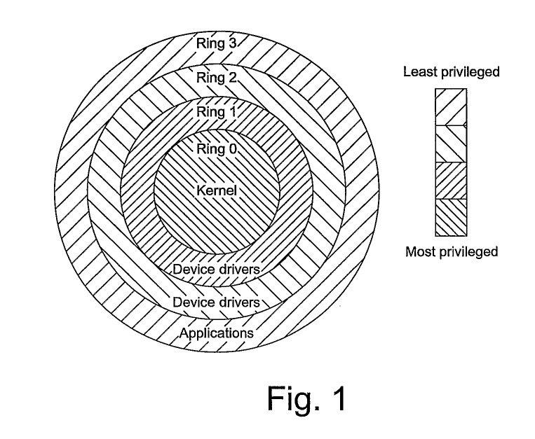

### DETAILED DESCRIPTION

The present invention provides a data leak protection method. This method is also referred to herein as “Enforcer” and the terms “Enforcer” and “data leak protection” should therefore be regarded as referring to the same method, system or application.

The present invention may be integrated with Microsoft Active Directory in order to support groups and users policies. An organization's security team may easily define a protection policy according to the organization's specific requirements.

In general, the present invention may run in two different modes: Online and offline. When a user is connected (online mode) to an organization's Domain server (Active Directory), his login process is performed based on his personal and predefined user account privileges in the Domain Active Directory. In this case, the present invention may load the user's security policy from the Active Directory as part of the general login process.

When the user is disconnected (Offline mode) from the organization's Domain server (Active Directory), his login process is performed based on his personal text-password which is stored locally in his working PC (logged machine) and a local user account in his working PC. In this case, the present invention may load the user security policy locally as part of the general login process. The user local security policy is identical to the last logged security policy in the organization Active Directory.

The main objective of integrating the present invention with Microsoft Active Directory is to store the Enforcer security policy for each user within a world-wide standard and to integrate the present invention within the users' login process while users get their personal privileges in the operating domain (logged domain) by using the standard personal SID (Security Token) generation. Other third party applications (such as Microsoft Exchange Server) use the Active Directory schema to store each user's personal records within the application.

In order to integrate the security application in accordance with embodiments of the present invention with Microsoft Active Directory, the Active Directory Schema may be extended based on pre-defined properties of a security policy rule-base associated with the present invention.

This Active Directory schema represents a “map” of an organization's IT resources in a hierarchical structure using forest, tree, trusted domains, each domain's users, each domain computers and much more. The Active Directory schema stores all object definitions and their pre-defined attributes.

Based on this defined standard, the security application in accordance with the present invention may extend the Active Directory schema as detailed below thereby enabling it to support Enforcer security policy objects and attributes:

[Remark: Class Objects must start with capital letters while Schema Attributes must start with lower-case letters.]
1. AnbEnforcrApplication—A root object which represents the monitored running application. This object definition contains the following schema attributes:
   a. anbEnforcerWindowTitle—The title (sub string) of a running window application.
   b. anbEnforcerMainModule—The running application main module (executable file: dll or exe) of a running application.
   c. anbEnforcerProgramName—The running application program name (typically same as the main module name).
   d. anbEnforcerSecondaryModule—The running application secondary module.
2. AnbEnforcerRule—A root object which represents the Enforcer security policy record for a specific running application. This object definition contains the following schema attributes:
   a. anbEnforcerTargetName—the targeted application which the source application asks to export the information to using a clipboard paste into activity.
   b. anbEnforcerSourceName—the source application that is asks to copy the information from.
3. AnbEnforcrRulesGroup—A root object which represents the Active Directory Users Group which contains the present invention's security policy rule-base. In this manner, the organization security team defines users groups security policy only. Each user's account in the domain Active Directory is a member of pre-defined users group/s. Therefore, derived from the user's account membership, his personal Enforcer security policy is accumulated and applied at the user's login process. This mechanism is implemented using pre-defined relations. Each relation is defined using “Linked Attribute” which is named “member” attribute. When a “user” attribute is listed as a “member” in a users' group, the Enforcer security policy can be applied. This mechanism is very similar to the way users are related to their security groups in the domain Active Directory (like system Administrators users) in the Active Directory.

To ease the process of defining the Enforcer security policy, the present invention may provide a Security Team Configuration Tool that is used to define the Enforcer Rule-base for each user group.

The configuration tool enables an organization's security team to define the monitored application attributes and also enables the security team to define what user activities are forbidden (e.g. to define that source application “A” cannot export information to a target application “B”).

It is noted that before activities can be defined as forbidden or allowed, the security application, in accordance with the present invention, needs to ascertain the running applications on the computer or network to be protected. A “Sniffer” agent may be used to perform this task. In Windows 2000 (and later versions) Device drivers install a sniffer by calling the kernel mode API PsSetLoadImageNotifyRoutine that installs a Callback function which is such a sniffer. To stop the sniffer, the driver has to call PsRemoveLoadImageNotifyRoutine.

A simple representation of a security policy in accordance with an embodiment of the present invention is illustrated by an XML file below.

Security Policy Rule-Base—the security policy represents the enforced security policy for each user (authorized employee) in the organization. The policy defines what information exchange activities/events are forbidden inside the organization while users are logged into the organization domain controller (Active Directory). Any activity which is not defined as forbidden activity is allowed.

The Enforcer Security Policy is stored as part of the user's account in the organization's Active Directory. An example of a policy in accordance with an embodiment of the present invention is represented by the following XML file:

```
<root xmlns:xsl=“http://www.w3.org./2001/XMLSchema-
instance” xmlns:xsd=“http://www.w3.org./2001/XMLSchema”>
  <Imports>
  </Imports>
    <Exports>
      <Process ID = “1”>
        <ProgramName> Notepad.exe </ProgramName>
        <WinTitle ID =“1”> Notepad </WinTitle>
        <Module ID = “1”> GDI32.dll </Module>
        <Module ID = “2”> USER32.dll </Module>
      </Process>
      <Process ID = “2”>
        <ProgramName> Write.exe </ProgramName>
        <WinTitle ID =“1”> WordPad </WinTitle>
        <Module ID = “1”> GDI32.dll </Module>
        <Module ID = “2”> USER32.dll </Module>
      </Process>
      <Process ID = “3”>
        <ProgramName> WordPad.exe </ProgramName>
        <WinTitle ID =“1”> WordPad </WinTitle>
        <Module ID = “1”> GDI32.dll </Module>
        <Module ID = “2”> USER32.dll </Module>
      </Process>
      <Process ID = “4”>
        <ProgramName> WinWord.exe </ProgramName>
        <WinTitle ID =“1”> Microsoft Word </WinTitle>
        <Module ID = “1”> GDI32.dll </Module>
        <Module ID = “2”> USER32.dll </Module>
      </Process>
      <Process ID = “5”>
        <ProgramName> Excel.exe </ProgramName>
        <WinTitle ID =“1”> Microsoft Excel </WinTitle>
        <Module ID = “1”> GDI32.dll </Module>
        <Module ID = “2”> USER32.dll </Module>
      </Process>
      <No_Copy ID = “1”>
        <From> Winword.exe </From>
        <To> Write.exe </To>
      </No_Copy>
      <No_Copy ID = “2”>
        <From> Winword.exe </From>
        <To> Notepad.exe </To>
      </No_Copy>
      <No_Copy ID = “3”>
        <From> Winword.exe </From>
        <To> WordPad.exe </To>
      </No_Copy>
    <Full_Screen_Access ID = “1”>
        <ProgramName> Enforcer.exe </ProgramName>
        <CRC> 0 </CRC>
      </Full_Screen_Access>
      <Full_Screen_Access ID = “2”>
        <ProgramName> csrss.exe </ProgramName>
        <CRC> 0 </CRC>
      </Full_Screen_Access>
      <Full_Screen_Access ID = “3”>
        <ProgramName> EXPLORER.exe </ProgramName>
        <CRC> 0 </CRC>
      </Full_Screen_Access>
      <Full_Screen_Access ID = “4”>
        <ProgramName> WMPlayer.exe </ProgramName>
        <CRC> 0 </CRC>
      </Full_Screen_Access>
      <Full_Screen_Access ID = “5”>
        <ProgramName> mplayer2.exe </ProgramName>
        <CRC> 0 </CRC>
      </Full_Screen_Access>
      <Full_Screen_Access ID = “6.1”>
        <ProgramName> iexplore.exe </ProgramName>
        <CRC> 0 </CRC>
      </Full_Screen_Access>
      <Full_Screen_Access ID = “7”>
        <ProgramName> RealPlay.exe </ProgramName>
        <CRC> 0 </CRC>
      </Full_Screen_Access>
      <Full_Screen_Access ID = “8”>
        <ProgramName> QuickTimePlayer.exe </ProgramName>
        <CRC> 0 </CRC>
      </Full_Screen_Access>
      <Full_Screen_Access ID = “9”>
        <ProgramName> SAFlashPlayer.exe </ProgramName>
        <CRC> 0 </CRC>
      </Full_Screen_Access>
      <Full_Screen_Access ID = “10”>
        <ProgramName> VLC.exe </ProgramName>
        <CRC> 0 </CRC>
      </Full_Screen_Access>
      <Full_Screen_Access ID = “11”>
        <ProgramName> mspaint.exe </ProgramName>
        <CRC> 0 </CRC>
      </Full_Screen_Access>
      <Full_Screen_Access ID = “12”>
        <ProgramName> POWERPNT.exe </ProgramName>
        <CRC> 0 </CRC>
      </Full_Screen_Access>
    </Exports>
  </root>
```

The present invention may be integrated with a security solution, e.g. a biometric signature system such as ANB's BioSign® Solution (see U.S. Pat. No. 6,687,390). Alternatively, the present invention may be implemented as a stand-alone security solution with a software tool that can be used to scan running applications. An example of such a software tool, commonly referred to as sniffer agents, is the ANB Sniffer Agent™.

In the case of an integrated solution, the user login process may be based on authenticating the user's biometric signature. An example of such an integrated solution may use the ANB Biosign® Identify and Access Management (IAM) system which provides stronger authentication than any text-password. In such an example, the user signs online and then, his sampled signature is compared against the user's stored signature (user's biometric identity) in ANB BioSign® Authentication Server. Integrating ANB Enforcer™ with ANB BioSign® provides high confidence about who is behind the forbidden activities which is detected by ANB Enforcer™.

The operation of the present invention will now be described with reference to a number of different “data leakage” scenarios.

Login Process—General

The present invention is an event driven application which provides Data Leakage Protection (DLP services) in real-time. In addition, the present invention may provide event transactions archiving for further inspection by a security team and for forensic information for future inquiries.

In general a user of a system equipped with the present invention may log into the organization's domain. As part of the login process the user will retrieve his personal user account credentials. The organisation's security policy will also be retrieved by the system in accordance with embodiments of the present invention from the domain Active Directory. The user may then work with his personal PC using his user credentials. While the user works on his PC, forbidden events may occur and as a consequence, the system in accordance with embodiments of the present invention will be able to respond to these events based on the user personal security policy.

In general, there are two modes of the login process: online and offline. An online login process is performed while the user is connected to the organization Domain Controller. An offline login process is performed while the user is disconnected from the organization Domain Controller. In the latter case, the login process is performed locally at the user's PC using the local user's account and the user's local security policy. The user's local security policy is identical to the last logged user's security policy which is stored in the domain Active Directory.

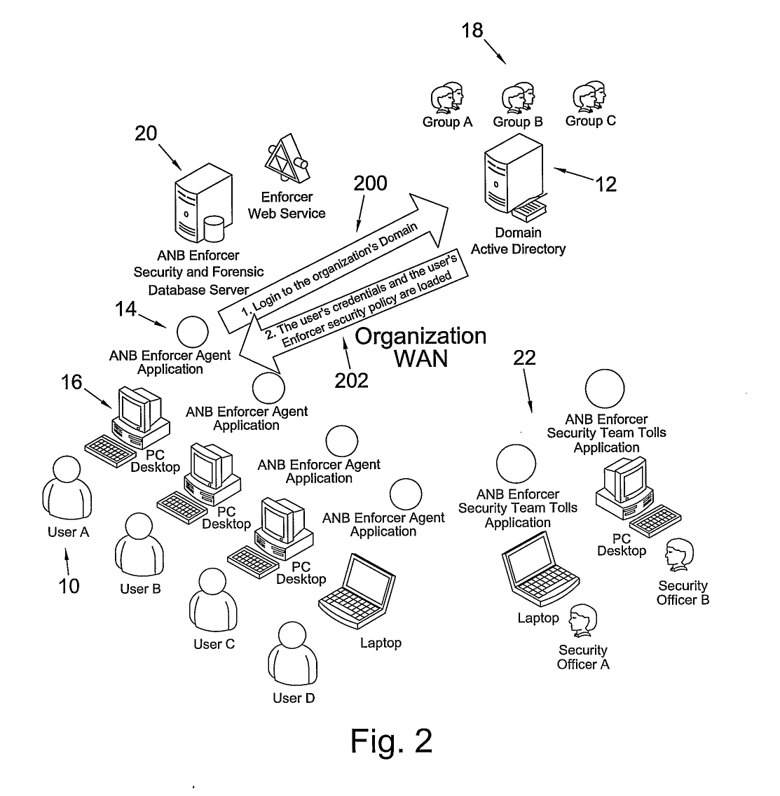

Online Login Process (FIG. 2)

The user 10 (organization authorized employee) logs into the organization's domain using his personal text-password and/or his biometric identity and/or his personal smart-card. Within this process, the user gets his credentials as derived from his user's account privileges in the organization Active Directory 12. This is the standard login process to the domain server while the user is connected (online mode). Within this process, the data leak protection application/system 14 in accordance with the present invention (referred to in FIG. 2 as “ANB Enforcer™”) runs on the user PC 16 and loads the user's Enforcer security policy from the domain controller (Active Directory 12). The user's security policy is derived from the user membership to user groups 18 which are defined in the organization Active Directory.

FIG. 2: Online User's Login Process to the Organization's Domain Controller
a) (Step 200)The user 10 logs into the Domain Controller using his text-password and/or biometric identity and/or Smart card key (Private Key).

b) (Step 202)The user 10 gets his credentials (SID—security token) and the data leak protection application loads the user's personal security policy.

It is noted that FIG. 2 also depicts a security and forensic database server 18 which may be used to record details of any forbidden events detected by the data leak prevention application. Events detected by a data leak prevention application may be sent to the server 20 and may also be forwarded to an IT security team 22.

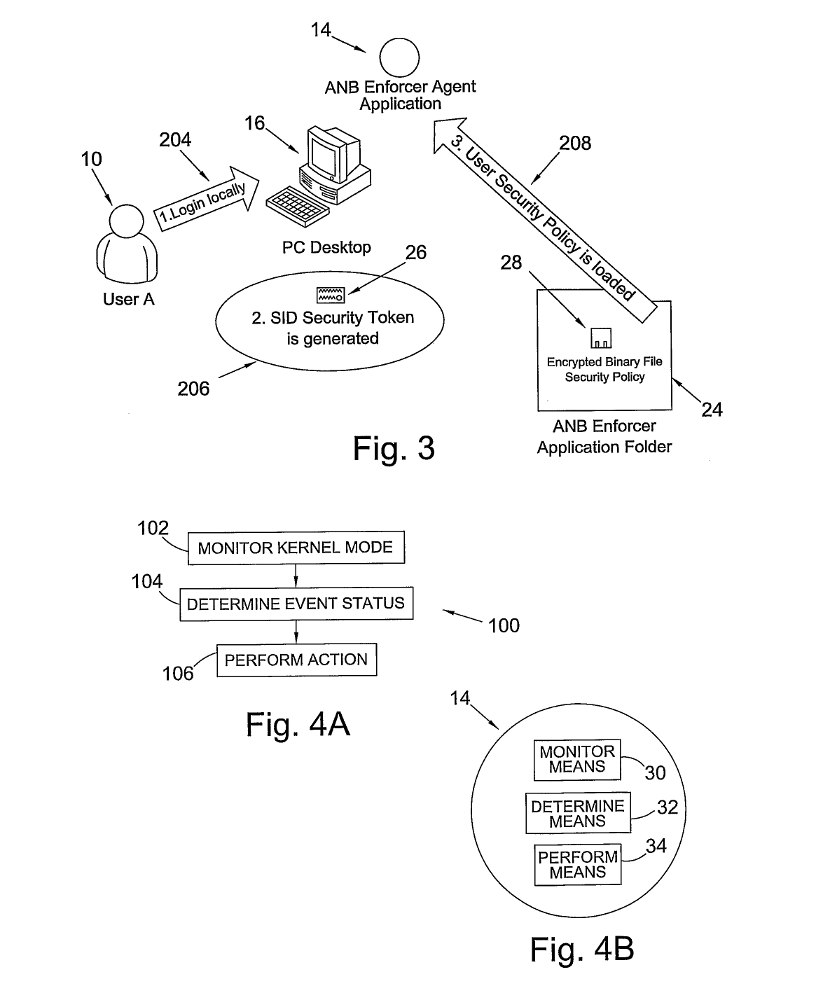

Offline Login Process (FIG. 3)

While the user's PC is disconnected from the organization's Domain Controller 12, the user 10 (organization authorized employee) logs on to his working PC 16 using his personal text-password and/or his biometric identity and/or his personal smart-card. Within this process, the user gets his credentials as derived from his local user's account privileges, in the working PC. This is the standard offline login process to the working PC while the user is disconnected (offline mode). Within this process, ANB Enforcer™ 14 which runs on the user PC, loads the user's Enforcer security policy from the ANB Application Folder 24 (encrypted binary file). This user's Enforcer security policy is identical to the last logged user's Enforcer security policy in the Active Directory 12. The user's Enforcer security policy is derived from the user membership to users groups which are defined in the organization Active Directory.

FIG. 3: Offline User's Login Process to the User's Working PC (Locally)
a) (Step 204)The user logs in to his working PC using his text-password and/or biometric identity and/or Smart card key (Private Key).
b) (Step 206)The user gets his credentials (SID—security token 26) and (Step 208) the Enforcer Agent loads the user's personal Enforcer security policy from an encrypted binary file 28 which is stored locally.

Only the user is logged into his PC (Online or Offline modes) ANB Enforcer™ loads the user personal Enforcer security policy and only then the ANB Enforcer™ DTP (Data Leak Protection) is activated.

FIGS. 4a and 4b illustrate a data leak protection method in accordance with embodiments of the present invention and a data leak protection system/application in accordance with embodiments of the present invention.

In FIG. 4a the data leak protection method 100 is represented in which in Step 102 the kernel mode of a computer is monitored for user-initiated events. In Step 104, the method determines whether an event is allowed or forbidden and in Step 106 appropriate action is performed.

FIG. 4b represents the data leak protection system/application that corresponds to the method of FIG. 4a. The data leak protection application 14 comprises three general components: a monitoring means 30 (corresponding to method step 102); determining means 32 (corresponding to method step 104); and, performing means 34 (corresponding to method step 106).

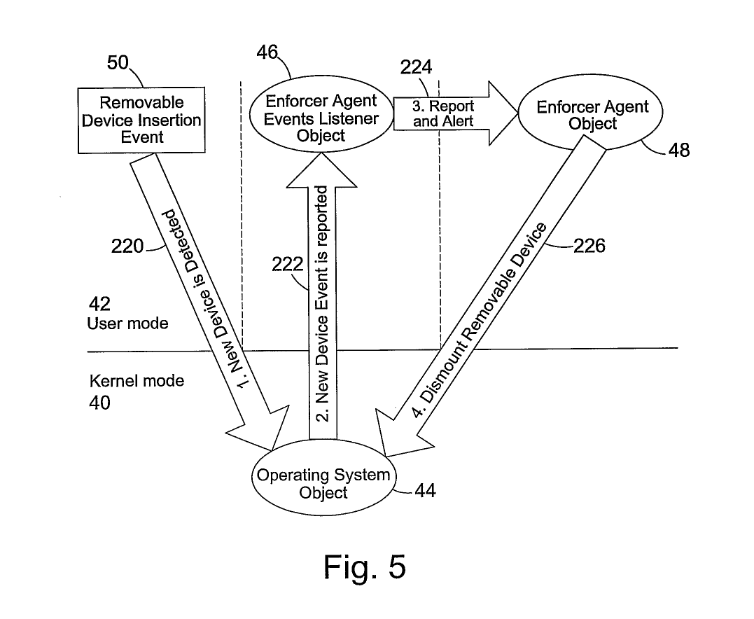

FIGS. 5 to 15 detail the operation of the data leak protection method/system/application of the present invention for the example of a PC in response to various data leak scenarios. Throughout FIGS. 5 to 15, it is noted that components within the PC are denoted as well as the various operational steps between the components.

Removable Device Mounting/Dismounting Process

FIG. 5 shows the mounting/dismounting of a removable device to the user's PC.

In an operating system, all removable device mounting events are detected by the operating system as part of the Plug-n-Play features. Examples of the “mounting” of a removable device Disk-On-Key include insertion into a USB port, Fire wire port, connection via Blue Tooth, connection via Infra-red device, PCMCIA connector, DVD RW, CD-RW, RS232 RS423, RS422, RS485 port, parallel LPT port etc. Removable devices may include iPhone, Palm, memory cards, U3 Disk On Key, ordinary Disk on Key and others.

FIG. 5 shows a representation of the kernel mode 40 and user mode 42 of the user's PC 16. It can be seen that the operating system 44 (operating system object or OSO) is located within the kernel mode 40. In FIG. 5 the data leak protection application is represented by two components, an Enforcer Agent Events Listener object 46 (EAEL) and Enforcer Agent Object 48 (EAO).

The mode of operation of the data leak protection application is now described.

In Step 220, a mounting/dismounting event 50 occurs and is detected by the operating system object 44 (OSO) running in kernel mode 40.

In Step 222, the OSO 44 sends a message to the Enforcer Agent Events Listener object 46 (EAEL).

In Step 224, the EAEL object 46 reports on a new removable device 50 to the Enforcer Agent object 48 (EAO). The EAEL 46 also generates a recorded event transaction and recorded security alert which may be sent to the security and forensic database 20 and also the IT security team 22.

The Enforcer™ object is a software component (DLL file) which is responsible for low-level operations in real-time such as: Windows messages hooking, new removable device dismounting, internal protection services and others. In Step 226, the Enforcer™ object 48 responds to the EAEL report received in Step 224 based on the user's personal security policy and where necessary, blocks the forbidden activity by dismounting the removable device using the operating system agent.

Applications Information Flow Process

Information exchange may occur between applications using the operating system clipboard, Drag & Drop or the GDI (graphic device interface) device context copy. In such cases, when information is copied from one running application, the data is in fact copied to the operating system clipboard or to shell data transfer objects such as, in Windows, DoDragDrop API. At this stage, the clipboard content or a shell data transfer object's memory content is changed. This event is reported [It is noted that if an ordinary copy occurs then the EAEL may capture clipboard changes in due course after it registers itself as a Clipboard Viewer. If, on the other hand, a Drag/Drop occurs then this would be monitored by API hooks as drag/drop events do not use the clipboard) to the operating system object (OSO) and then forwarded to the EAEL. When the EAEL gets the (“Draw Clipboard Change”) message from the OSO, it checks for the source of the information copy operation, in other words the EAEL “asks” itself: “what is the source application that initiated that information copy operation?”. After identifying the source of the information copy event, it checks the rule-base as to what other applications the source application is allowed to export information.

Only when the operating system activates an application window of a forbidden application (to which the information should not be exported), will the operating system clipboard be cleared by the EAEL object.

It is noted that a forbidden application may not be explicitly defined as forbidden. It can simply be an unauthorized application. If the source program in which the copy or drag operations took place, had opened a file that is defined as confidential then copy/paste, drag/drop operations can be done in the program itself only.

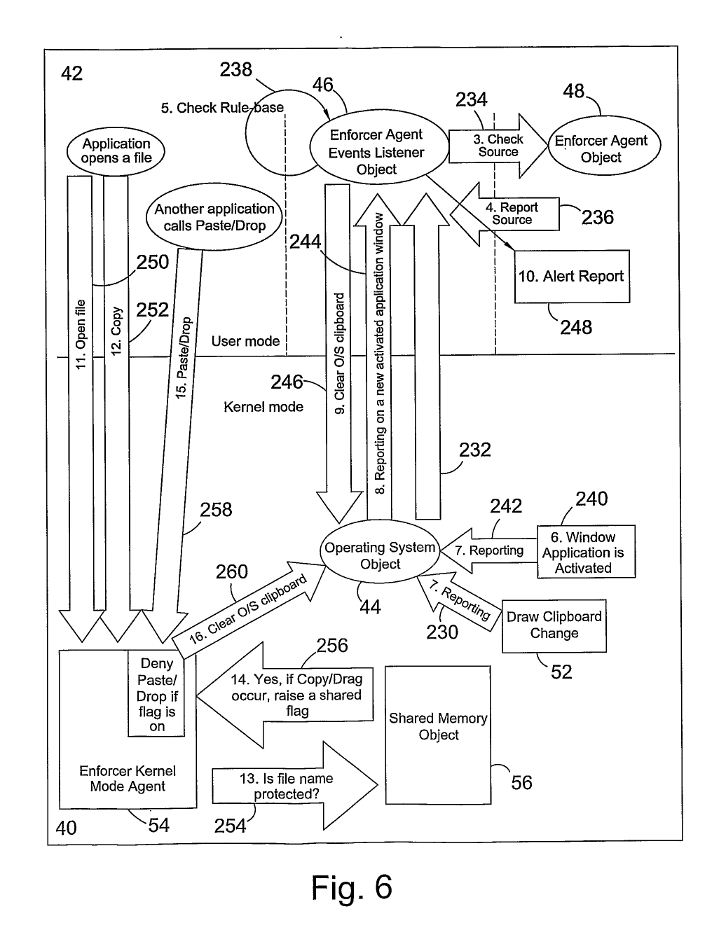

The above information exchange using the clipboard feature is depicted in FIG. 6. In Step 230, a clipboard event updates the operating system clipboard 52 and this is reported to the operating system object 44. In Step 232 the OSO 44 reports that the clipboard has changed to the EAEL 46.

In Step 234 the EAEL 46 detects the source application that triggered the clipboard change by checking with the agent object 48 and in Step 236 the EAO 48 (which is a low level program) reports the details of the source application to the EAEL 46.

In Step 238, the EAEL 46 then checks the rule-base to decide if the source application is allowed to copy data to other applications (the security policy will be checked). The events listener object 46 will then wait for further activity before taking any further action.

In Step 240, a new application is opened by the user. This application opening event is reported to the OSO in Step 242.

In Step 244 the OSO 44 reports to the EAEL 46 that a new application has been opened. The EAEL 46 can then take appropriate action depending on whether a copy to the new application is defined as forbidden or not. In the example of FIG. 6, it is not permitted to copy from the clipboard 52 to the new application and so in Step 246 the clipboard is cleared by the EAEL 46. Finally in Step 248, the EAEL 46 can alert (the IT security team 22) and record the event transaction (in the database server 20).

An independent process starts when a confidential file is opened and this process is also depicted in FIG. 6. This process additionally comprises the use of a component 54 of the data leak protection application 16 that is located within the kernel mode 40 of the computer (the Enforcer Kernel Mode Agent 54 in the figure).

As the confidential file is opened, an Open-File call is intercepted (at Step 250) by the EKMA. In Step 252, a Copy action is detected by the EKMA 54.

The file name of the file being opened is then checked in Step 254 against a list of protected files in a shared memory unit 56 located either within the kernel mode 40 (as depicted in FIG. 6) or alternatively within user mode 42 (not shown in FIG. 6). If the file is marked as confidential/protected then, in Step 256, a warning copy-from-protected-file flag is set to “true”.

Subsequently, if another application calls a “paste operation” (Step 258) then the clipboard/copy buffer will be cleared in Step 260 if the copy-from-protected file flag is “true”. In addition Drag/Drop shell calls are intercepted by the EKMA.

Printscreen Information Flow Process

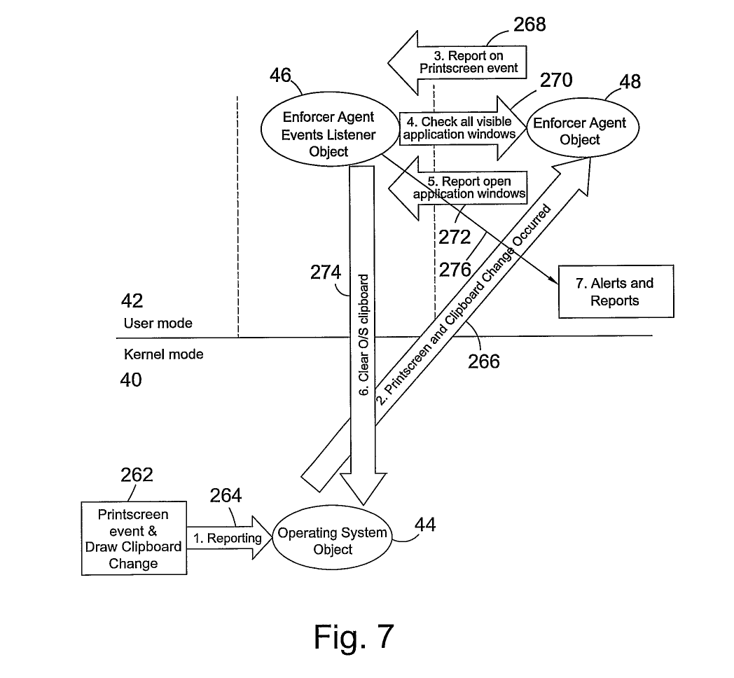

FIG. 7 illustrates the operation of the data leak protection application in accordance with an embodiment of the present invention when a “Printscreen” event is initiated by a user.

A Printscreen event may be initiated by typing on the Printscreen key on a computer keyboard and it is noted that this event once selected is reported to the operating system object (OSO).

Turning to FIG. 7 therefore, when a Printscreen event occurs (262) a change results in the operating system's clipboard. In Step 264, the clipboard reports this change to the operating system object 44.

In turn, in Step 266, the clipboard change is reported from the OSO to the Enforcer Agent Object (EAO).

The printscreen event is then reported to the Enforcer agent listener object in Step 268 by the low level EAO program.

In Step 270, the EAEL responds by requesting from the EAO a list of all visible windows. In Step 272, the EAO reports back to the EAEL with information relating to the visible application windows (the EAO sends a list of windows and their owning application names).

In Step 274, the EAEL decides whether to clear the clipboard (based on the active security policy). In Step 276, a copy of the printscreen image may be saved to the security and forensic server 20 for inspection and forensic purposes and the EAEL may send a report about the event.

Graphic Device Interface (GDI) Information Flow Process

When a running application 60 at the user mode level calls a GDI function/resource for getting Printscreen image copy, the data leak protection application according to an embodiment of the present invention may intercept the GDI API (Application Programming Interface) and, in the event of a forbidden exchange event may reject the API call.

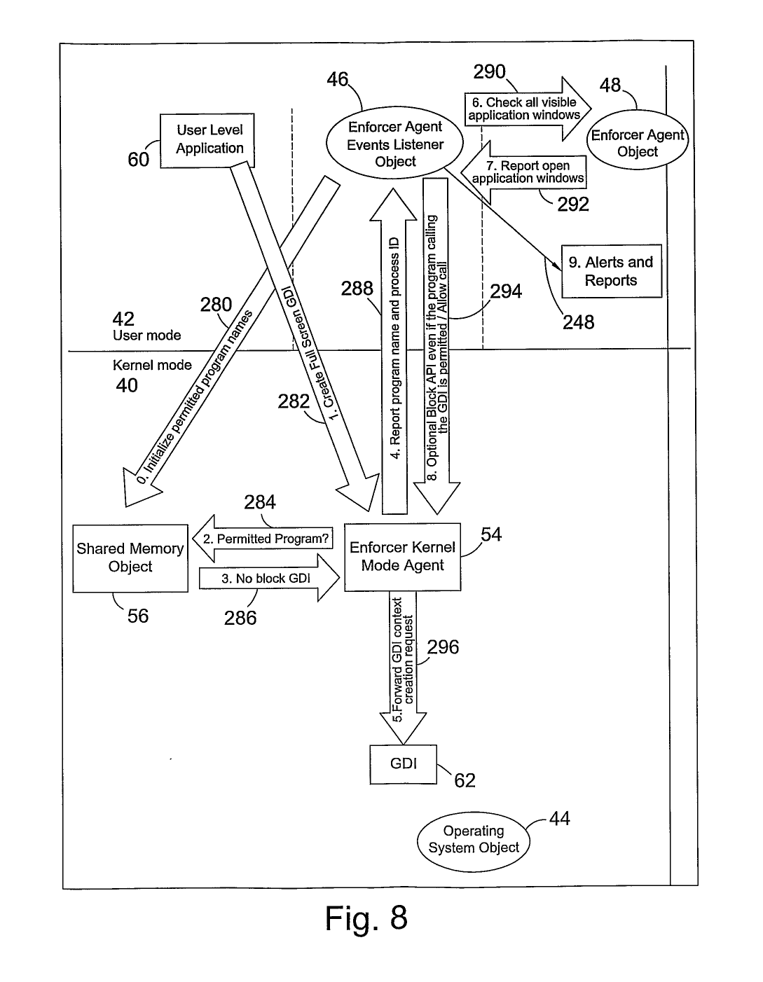

Turning to FIG. 8, in Step 280, a shared memory object 56 is initialized with a list of program names (including their file hash code) that are permitted to place a GDI API call. This initializing of the shared memory object is initiated by the Enforcer Agent Events Listener object 46 based on a pre-defined rule base (e.g. from the user's security policy).

When a GDI API call for full screen access is made in Step 282 by a user level application 60, the call is intercepted by the Enforcer Kernel Mode Agent (EKMA) 54. In Step 284 the EKMA checks against the list of allowed applications stored in the shared memory object 56 whether the program that has initiated the call is authorised to do so. In Step 286, the shared memory object reports back to the EKMA.

In Step 288 the EKMA reports the call (including the program name of the program that made the call and the process ID) to the events listener object (EAEL) 46.

The EAEL then performs a check of all visible application windows with the agent object 48 (EAO) in step 290 and in step 292 the EAO reports back to the listener object on all open application windows. In Step 294 the EAEL checks if the information exchange is allowed in the rule base and if it is forbidden calls the kernel mode agent to reject the GDI API call or if it is allowed informs the kernel mode agent that the call can be forwarded. In Step 296 the kernel mode agent forwards the allowed GDI call to the GDI 62.

It is noted that in the event of a forbidden call then the listener object may output an alert notification and report on the forbidden GDI call transaction (Step 298). A copy of the Printscreen image may also be saved for future inspection and for forensic purposes.

File Deletion Process

When a file deletion event occurs by the user and/or by a running application and/or by the operating system internal process, the file deletion event may be intercepted by the EKMA and is reported to the EAEL. The EAEL alerts and records the file deletion transaction based on the organization security policy. It supports protection on folder deletion events.

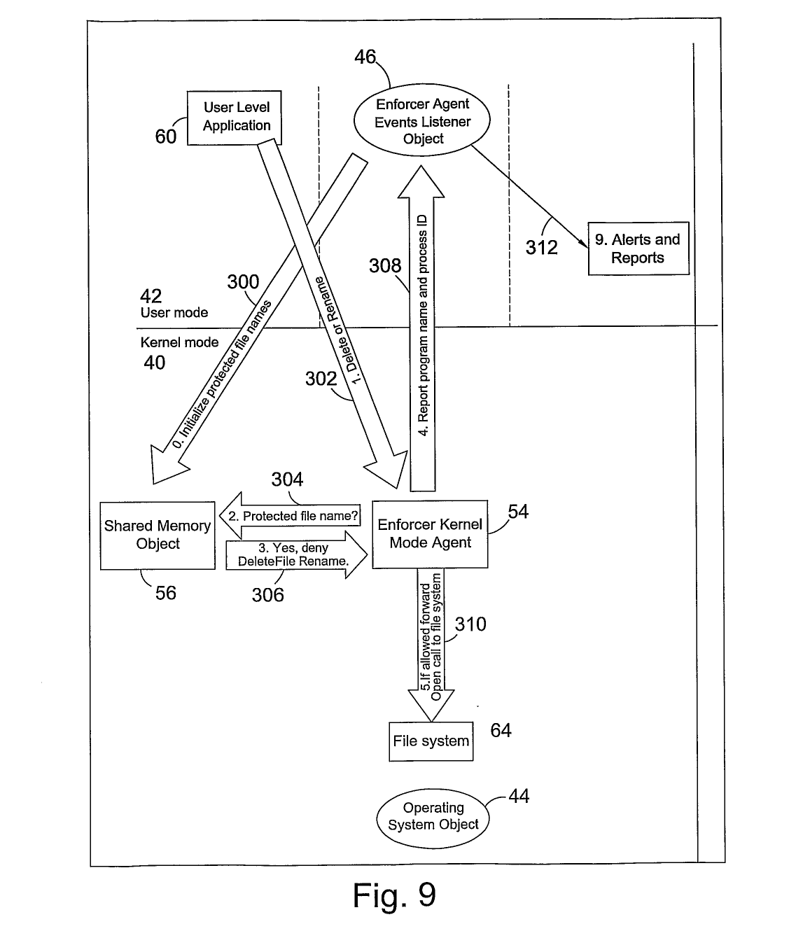

Referring to FIG. 9, a shared memory object 56 is initialized with a set of protected file names by the Enforcer Agent Events Listener object 46 (in Step 300). In addition a list of allowed directories can be managed such that files not in these directories cannot be renamed/deleted.

In Step 302, when a file and/or folder deletion event is called by a user level application 60, the call runs through EKMA which in turn (Step 304) checks the shared memory unit to see if the file is confidential/protected or not. In Step 306 the memory object 56 reports back to the kernel mode agent 54 as to whether the call is allowed or not.

In Step 308 the kernel mode agent reports about the call to the listener object (file name, process ID and process name are reported to the EAEL).

In Step 310, if the call is approved (from Step 306) then the kernel mode agent passes the call to the operating system 44 (file system 64). If the file is reported as protected in Step 306 then the call is denied and thus not passed to the operating system. The deletion or deletion denial report is recorded in Step 312 by the EAEL.

File Renaming Process

The file renaming process is handled by the present invention in an almost identical way to file deletion, however, renaming involves a new name. If the file is confidential/protected then the new name can differ only by path but not by file name, in other words it is a copy/ move action. When a file renaming event occurs by the user and/or by a running application and/or by the O/S internal process, the file renaming call is intercepted by the EKMA which forwards the event message to the EAEL. The EAEL alerts and records the file renaming transaction based on the organization security policy. The present invention protects against folder renaming events

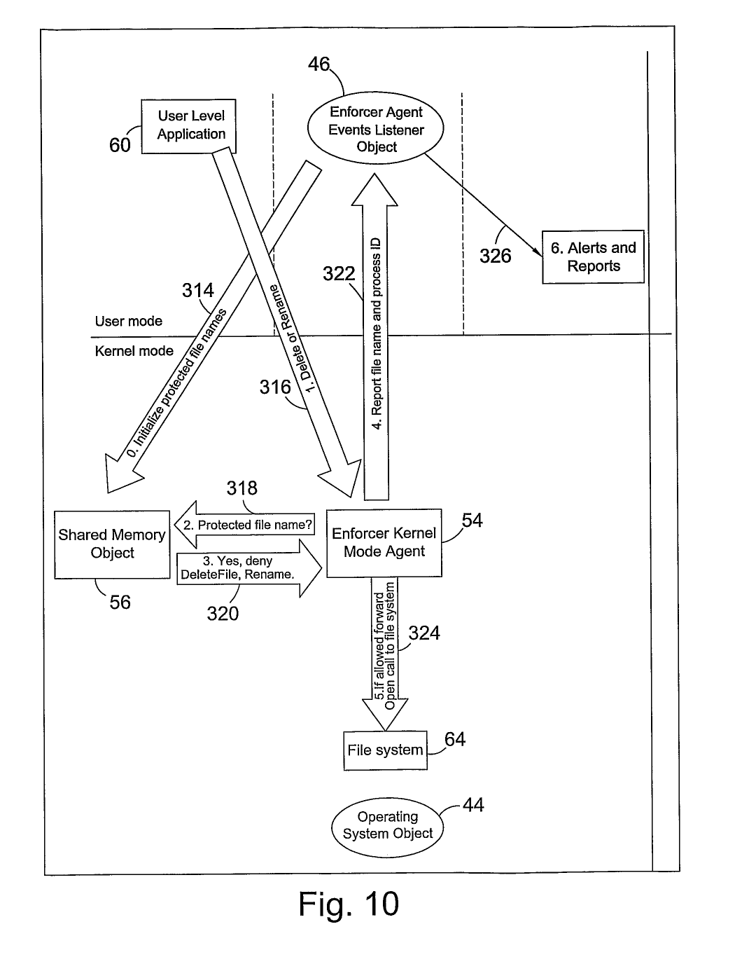

Referring to FIG. 10, in step 314 a shared memory object 56 is initialized with a set of protected file names by the Enforcer Agent Events Listener object 46.

In Step 316, when a file and/or folder renaming event is called by a user level application 60, the call runs through the EKMA 54. The EKMA, in step 318, checks the shared memory unit 56 to see if the file is confidential or not. In Step 320, the shared memory object reports whether the file is confidential or not.

In Step 322 the EKMA 54 reports about the call to the EAEL 46.

In Step 324, if the call is approved it is passed to the operating system 44. If the call is denied then the EKMA does not pass the file renaming call to the operating system.

The renaming or renaming denial report is recorded in Step 326 by the EAEL.

It is noted that FIG. 10 is quite similar to FIG. 9 but is focused on renaming rather then on deletion.

Network Change Event

When a new IP address is bound to a PC's NIC (Network Information Centre) MAC (Media Access Control) and/or the logged Domain is changed and/or the PC name (NetBIOS name) is changed then the present invention may be configured such that an event message is sent by the OSO to the EAEL. The EAEL alerts and reports on this networking change event in order to continue tracking down the PC machine which is being used by the user. The EAEL reports on:
a) The new assigned IP address, which is bound to the PC MAC Addresses
b) The updated domain
c) The updated PC name (NetBIOS name).

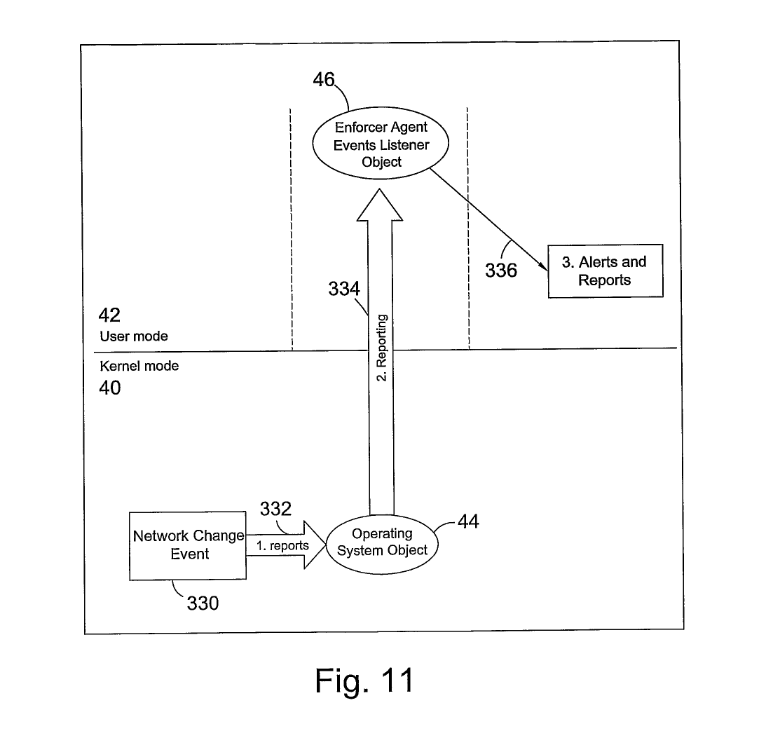

Referring to FIG. 11, a network change event occurs (330) it is reported by the OSO to the EAEL in step 332 (the network change may be reported by miniport drivers and then to higher level Device Drivers and Class Drivers (class drivers serve various types of different higher level drivers that all interact with the same hardware)). A network change event may comprise any one of the following changes: new assigned IP address, new logged domain, new PC name (NetBIOS name). In Step 334, the EAEL 46 alerts and reports on the network change event. In Step 336, the EAEL outputs an alert and reports on the network change event.

Console Command Event

When a console command is Entered, the Enter command is captured by a keyboard hook and the command itself is extracted from the console buffer by the EKMA which is injected into the console process.

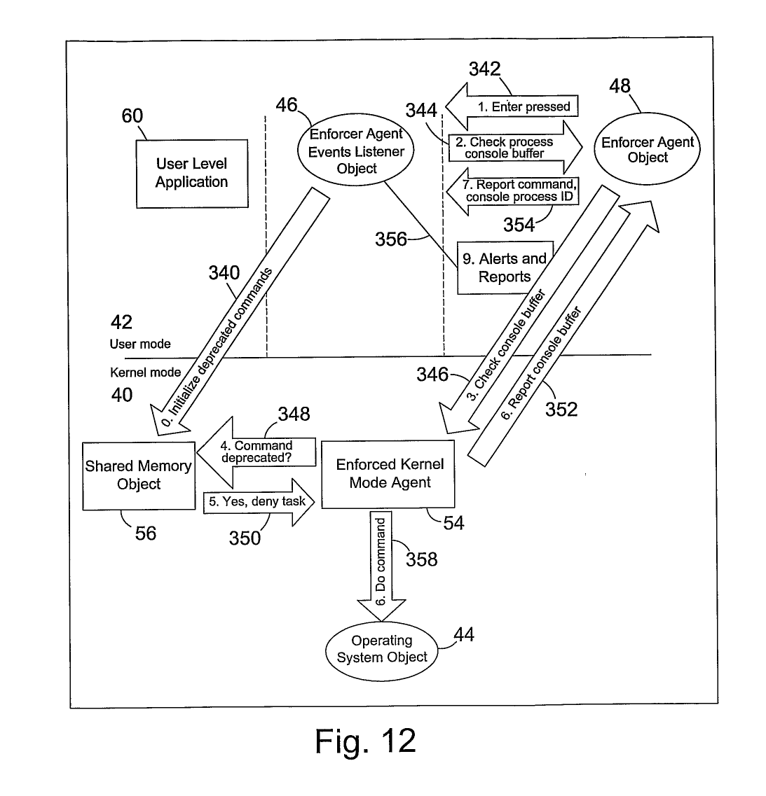

Referring to FIG. 12, in Step 340 a shared memory object 56 is initialized by the Enforcer Agent Events Listener object 46 with a set of commands that are not allowed (this is the “Black List” method). Alternatively, the shared memory program can be loaded with a list of commands that are allowed (this is the “White List” method).

In Step 342, the “Enter” key is pressed within a console application 60 and the event is detected by the keyboard hook in the EAO 48 (Low level C++API—Enforcer Agent Object) and reported to the EAEL 46.

In Step 344, the EAEL 46 calls the EAO 48 for the console buffer in order to receive the command that was executed by the console application and in Step 346, the EAO calls the EKMA.

In Step 348, the EKMA 54 checks the console command and sends it to the shared memory unit 56 to verify the command is authorized.

In Step 350, the shared memory unit 56 sends a reply with the command to the EKMA.

In Step 352, the EKMA sends the command buffer to the EAO. If the command is forbidden an additional report is generated.

In Step 354, the EAO sends the message with the command string to the EAEL. The EAEL then reports (in Step 356) the event.

If the command is approved (following Step 350) then it is relayed as is in Step 358 to the operating system 44.

Task Scheduler Request

A task scheduler request schedules the activation of an application, command or batch file if a condition or time is met. In accordance with embodiments of the present invention, the EKMA intercepts the request and sends the command in it to the shared memory unit to see if the command or it's components are not authorized.

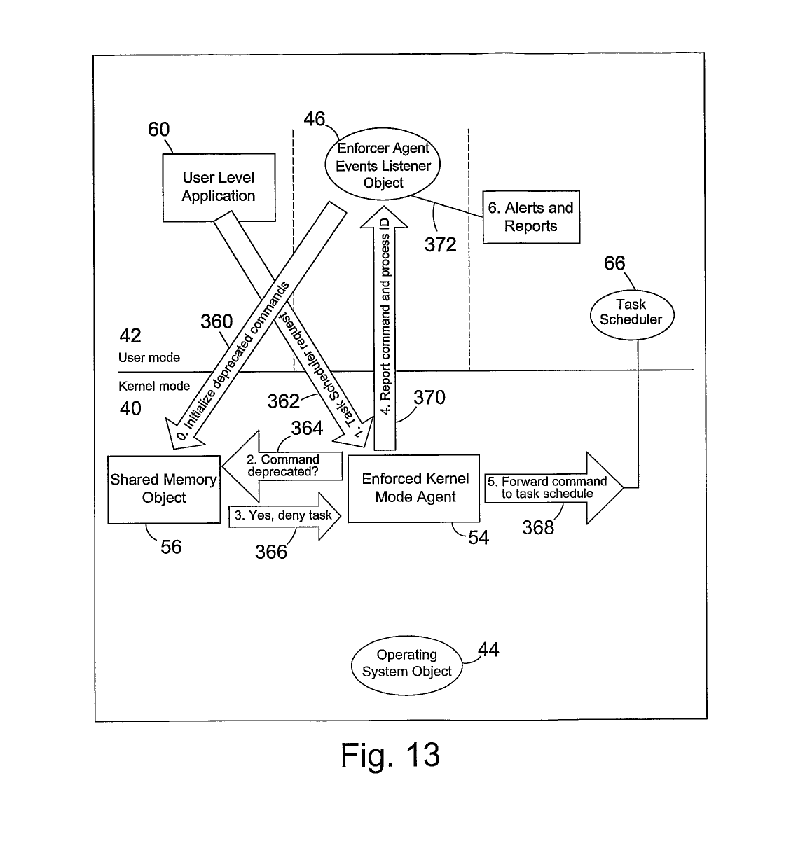

Referring to FIG. 13, in Step 360, a shared memory object 56 is initialised with a series of commands that are allowed (Black list method)/forbidden (White List method) by the EAEL 46.

In Step 362, the EKMA 54 intercepts a call by the Task Scheduler 66 to schedule a task for a user application 60.

In Step 364, the EKMA 54 extracts the command from the task and asks the shared memory unit 56 to see if the command is authorized and in Step 366 the shared memory unit reports on the allowability of the command.

If the command is authorized it is forwarded in Step 368 to the Task Scheduler 66 for scheduling in order to be performed later. The EKMA 54 in parallel reports in Step 370 the Task command to the EAEL which in turn sends (in Step 372) a report for record.

Save As Event

A Save As event can be identified by embodiments of the present invention based on what APIs, or interfaces the software calls after it opens a confidential file. The EKMA knows that a confidential file was opened by calling a shared memory unit in which the file name appears in a list.

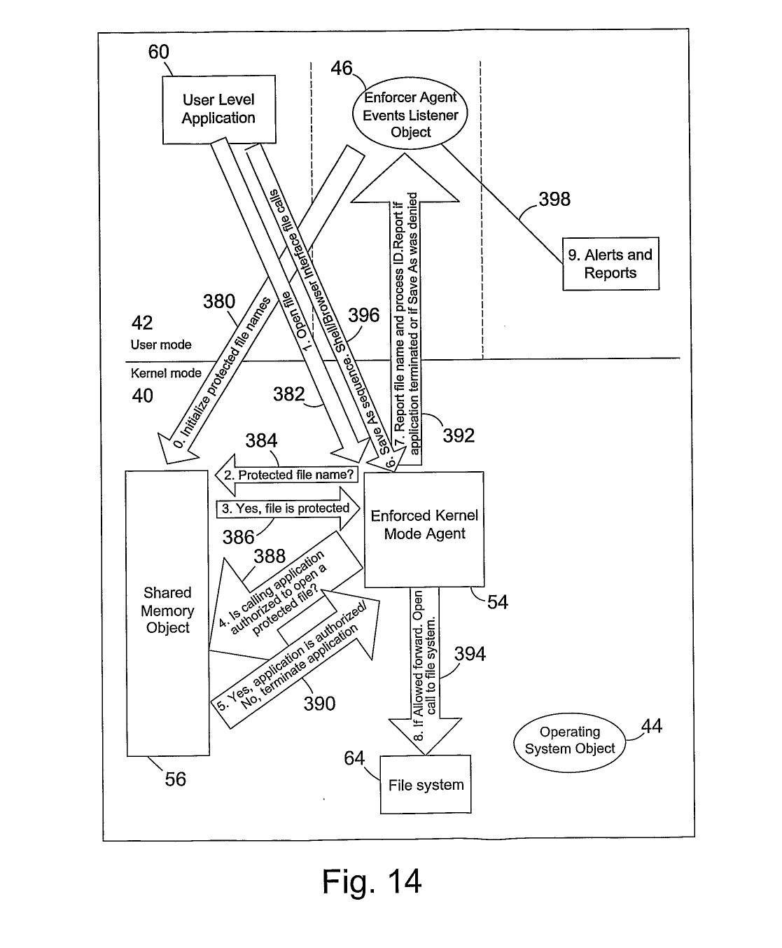

Referring to FIG. 14, a list of several protected files can be defined. In addition a list of allowed directories in which only files within these directories can be deleted, renamed, Saved-As and sent by e-mail can be defined. In Step 380, a shared memory unit 56 is initialized with the set of protected file names by the Enforcer Agent Events Listener object 46. In addition the list or another list contains programs that are allowed to open protected files.

In Step 382, a user level application 60 opens/creates a file and the OpenFile or CreateFile request is intercepted by the EKMA 54.

In Step 384, the EKMA 54 checks the shared memory unit 56 to see if the file name is protected (either if explicitly protected or if allowed directories are defined, and the file is not in an allowed directory) and in Step 386 the shared memory unit 56 reports on the protection status of the file name.

If the file is confidential then in Step 388 the EKMA 54 checks (with the shared memory unit 56) if the application is authorized to open or create files with a protected name.

In Step 390, the shared memory calls the EKMA to report if the application is authorized to access confidential files or not.

If the application is not authorised then the application may be terminated and a report sent to the EAEL (Step 392).

In Step 394, if the application is authorized then the request is forwarded to the operating system 44 (file system 64).

If the application is authorised to access confidential files then the EKMA 54 remembers that a confidential file was accessed.

Future sequences of API calls or interface calls that are identified as “Save As” are blocked (in Step 396) and a report is sent to the EKMA.

In Step 392, if the application is terminated because it is not allowed to access protected files or if a Save As sequence of API calls is identified, a report is sent from the EKMA to the EAEL. The EAEL reports (in Step 398) the event for record.

Printing

This embodiment of the invention relates to Print monitoring. If a protected file is opened by an application and later the application prints documents a report is generated.

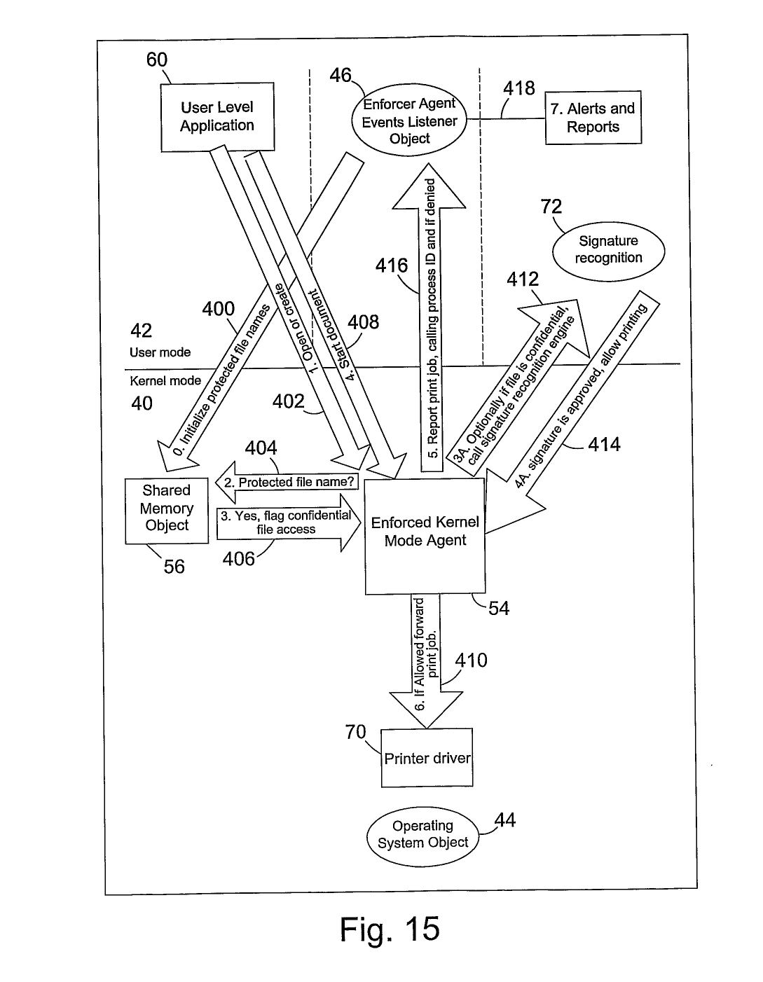

Printing often occurs after data files are accessed. If one of these accessed files is confidential then printing should be restricted to a predefined policy. In the example of FIG. 15, the policy is enforced by the system manager.

Referring to FIG. 15, in Step 400 a shared memory unit 56 is initialised with a list of protected file names. In addition, a list of allowed directories can be also loaded. If allowed directories are defined then files out of these directories are protected by default.

In Step 402, a file is opened by a user application 60 and the EKMA 54 intercepts the OpenFile or CreateFile call.

In Step 404, the EKMA 54 checks with the shared memory unit 56 if the file name appears in the list of protected/ confidential file names in the shared memory unit 56.

In Step 406, the shared memory unit 56 reports back to the EKMA 54 on the status of the file name and if the file name is confidential a protected file flag is raised, e.g. set to “true”.

In Step 408, the EKMA intercepts a call to a function that initiates printing.

In Step 410, if the file is not protected or if there is no limit on printing protected files, the printing API e.g. Windows StartDoc is transferred to the printer driver 70

Optionally in Step 412, the EKMA can invoke a signature recognition engine 72 to verify, in Step 414, that the user is indeed authorized to print the confidential file.

In Step 416, the print job report is sent to the EAEL 46 including whether it was denied or not. The EAEL 46 sends a report to the database for record in Step 418.

The skilled person would appreciate that the order of the process steps in FIGS. 5 to 15 may be changed slightly without affecting the operation of the invention.

The present invention may usefully comprise a further security feature that prevents the data leakage protection application of the present application from being disabled. This “watch dog” feature may be run in the operating system background in order to provide real-time protection while a user uses his PC.

Any attempt to close the data leakage prevention application or data leakage protection will result in rebooting the running operating system and reloading data leakage protection application. This way, the PC is operational only when it is being protected by the data leakage protection application of the present invention.

Further attributes and advantages of embodiments of the present invention are discussed below and in particular it is noted that the present invention may extend to:
1) A method of controlling the operating system access to confidential data. This may be achieved as follows: API calls or system function calls may be redirected through a module, named Agent. The Agent may check the name and a hash code of the program that requires access to system resources or files. Whether the program is allowed to access the resource or not depends on a data leak protection policy which may be defined either locally or by a remote server in which Active Directory or other technology is defined. The policy database may include graphic interface management tools that facilitate policy definition.
2) A method of controlling the operating system access to confidential data. This may be achieved as follows: API calls or system function calls—SYSENTER—may be redirected through a module, named Agent. The Agent may check whether the resource is defined as protected by the local or remote server policy. If it is protected then the Agent may check what operations can be performed on/with the resource and if the program name and its hash code grant the calling program rights to perform these operations. Whether the program is allowed to access the resource or not depends on a data leak protection policy which may be defined either locally or by a remote server in which Active Directory or other database is defined.
3) A method of preventing Copy/Paste, Drag/Drop from an application—that is listed as protected in a policy database—to an application that is not listed as protected.
4) A method of preventing Copy/Paste, Drag/Drop from an application that is listed as protected after it had opened a confidential file and a second application calls Paste or Drop even if the second application is listed as protected. Paste and Drop may be allowed by the second application if and only if it only opened confidential files with the same level of confidentiality as the file from which data was copied. In such a case the Paste operation may not be denied but the clipboard/copy buffer may be cleared immediately after.
5) A method of preventing full screen access from applications that are not listed as eligible to be granted such access. The method does not deny full screen access rights from programs that are listed as eligible applications in a local or remote server policy database. An additional option is that a program which is not in the permitted list may be granted full screen access rights as long as no listed program runs. The incentive is that listed programs may be able to access confidential files and thus can display them. Thus no action which is equivalent to Print Screen should be allowed when confidential files are displayed or possibly displayed.
6) A method of dismounting /ejecting removable storage devices. The ejection may be triggered by simple insertion of a removable storage device against the organization policy or by an explicit copy attempt of confidential files to the removable storage device. Ejection may also be triggered by Paste/Drop (Windows Drag & Drop) from a protected file in a program that accessed a file that was opened or created on the removable storage device.
7) A method of allowing access rights to system resources, including but not limited to, confidential files, by hand gesture/signature recognition. API hooks or system call hooks may be used in order to activate the signature recognition when system resources are required. System resources may be full screen access (GDI device handle), a confidential file Open function call, other resources such as the printer when Windows StartDoc or an equivalent printer API in other operating systems is called. The signature recognition engine may be implemented as visual password recognition engine that is based on wide hand movements on a touch screen or may be based on ordinary hand signature recognition through pen stylus.
8) A method by which Print Screen events may be analyzed and by which programs that are allowed to open confidential files and to display them may be monitored. If such a program has a visible window and it runs while Print Screen takes place, the Print Screen operation may be denied.
9) A method by which print jobs of confidential files may either be denied or require hand gesture/hand signature recognition. The method may be based on API hooks or system call hooks.
10) A method by which Save As operation of confidential files may be monitored and/or prevented. First an Open operation of a confidential file may be detected. The file may be defined as confidential by the local or remote server policy, using technologies such as Active Directory. The confidential file name may then be loaded into shared memory. The shared memory may be accessed whenever a file is opened. If the file name is listed as confidential then any subsequent calls to the Save As option may be blocked or may require hand signature or hand gesture based visual password.
11) An alert system which reports possible risks to the safety of confidential data that may be recorded on the computer storage media. A method by which the conditions for sending an alert may be defined on the local computer or on a remote server or both. The definitions of these conditions are stored by using technologies such as but not limited to Active Directory.
12) A report system which may report all events that might be related to data loss risk even if the risk is low. The report may be stored both locally and in a remote server. Local storage may be used as backup.
13) A watchdog system that guards the Enforcer software against closure. The watchdog is a Service (background program) that checks the responsiveness of the main program. It may either be implemented as software or as hardware. If after a predefined interval, the Enforcer does not respond, the computer may be shut down in order to reduce possible data leakage out of the organization.

14) A method of defining applications/programs that are listed as “white” which means that under predefined rules they may be allowed to access system resources. Some system resources such as full screen access, should be accessed only if the application that uses the resource appears in the white list. There may be different white lists for different resources, e.g. a white list of the printer, a white list of programs that can access confidential files etc. The white list may be stored locally or on a remote server. The definition of the white list may use policy databases such as Active Directory.
15) A method of defining applications/programs that are listed as “black” which means that they are not allowed to access system resources. The black list may be stored locally or on a remote server. The definition of the black list may use policy databases such as Active Directory.
16) An adaptive method of online detection of programs with suspicious behaviour, namely Gray Scale List. The method builds an online policy for such programs and may limit their access to system resources by API hooking and/or system call hooking e.g. Windows SYSENTER.
17) A method of combining Save As limits with Gray Scale List applications. The restrictions may be according to the severity of the threat. In addition, if the program is suspected to be malicious code, no updates of existing files may be allowed. Write APIs calls may be denied by API hooking or by system call hooks.
18) A method and software for calculating CRC—Hash Code of the first, for example 100, kilo bytes of each program in a list and of writing the program CRC and name in a text file for later use by the administrator. In the policy database, the CRC may be ignored if the CRC tag that defines the program is set to 0, e.g. <CRC>0</CRC>. The hash code is an identification tool which may be used to help verify that the program is authentic. If there are several versions on the program, several entries may have to be written.

```
<Process ID = “1”>
<ProgramName> Defender.exe </ProgramName>
  <WinTitle ID =“1”> DLP Defender </WinTitle>
  <CRC> 11312841 </CRC>
  <Module ID = “1”> USER32.dll </Module>
  <Module ID = “2”> KERNEL32.dll </Module>
</Process>
<Process ID = “2”>
<ProgramName> Defender.exe </ProgramName>
  <WinTitle ID =“1”> DLP Defender </WinTitle>
  <CRC> 78442777 </CRC>
  <Module ID = “1”> USER32.dll </Module>
  <Module ID = “2”> KERNEL32.dll </Module>
</Process>
```

It is noted that although the present invention may be referred to above with reference to the “Enforcer application” or security application or data leak protection application, the skilled person would appreciate that the above description also applies to the corresponding data leak protection method and data leak protection system. References to “application” should therefore be understood to encompass the method and system of the present invention when incorporated into and running on a computing device.

It is also noted that the present invention may be applied to any suitable computing device, such as computers, servers, networks, PCs, laptops, “smartphones”, PDAs and any other processing means where data leakage is a potential issue. The term “computing device” should therefore be understood to encompass all such devices and processing means.

It will be understood that the embodiments described above are given by way of example only and are not intended to limit the invention, the scope of which is defined in the appended claims. It will also be understood that the embodiments described may be used individually or in combination.

1. A data leak protection method for managing user interaction with a computing device, the computing device comprising a kernel mode of operation and a user mode of operation, the method comprising:
monitoring the kernel mode of the computing device in order to detect user-initiated events;
determining whether a given user-initiated event has a forbidden status or an allowed status;
performing an action in dependence on the status of the given user-initiated event.

2.-33. (canceled)

34. A method as claimed in claim 1, further comprising one or more of the following: providing a data leak protection object in the user mode of the computing device; providing a data leak protection agent in the kernel mode of the computing device; providing a data leak protection agent in the user mode of the computing device.

35. A method as claimed in claim 34, wherein the method comprises a data leak protection object in the user mode of the computing device and the data leak protection object is injected into every running application in the user mode of the computing device.

36. A method as claimed in claim 35, further comprising injecting computer code into executable files in order to provide the data leak protection object in the user mode of the computing device.

37. A method as claimed in claim 34, wherein the method comprises a data leak protection object in the user mode of the computing device and the monitoring step comprises one or more of the following: the data leak protection object listening to kernel mode message traffic; the data leak protection object listening to user mode message traffic; the data leak protection object receiving notifications from an operating system object in the kernel mode whenever a user-initiated event occurs; the data leak protection object receiving notifications from code injected into every running application in user mode, whenever a user-initiated event occurs.

38. A method as claimed in claim 34, wherein the method comprises a data leak protection agent in the kernel mode of the computing device and wherein the monitoring step comprises the data leak protection agent intercepting a system call from a user mode application.

39. A method as claimed in claim 34, wherein the method comprises a data leak protection agent in the kernel mode of the computing device and the determining step either comprises the data leak protection agent checking with a kernel mode memory unit to determine if the system call relates to a forbidden status event or comprises the data leak protection agent checking with a user mode memory unit to determine if the system call relates to a forbidden status event.

40. A method as claimed in claim 34, wherein the method comprises a data leak protection agent in the kernel mode of the computing device and the method further comprises embodying the data leak protection agent in the kernel mode of the computing device within a device driver that hooks to system calls from user mode applications.

41. A method as claimed in claim 1, wherein the determining step comprises checking a monitored event against a database containing a data leak protection security policy.

42. A method as claimed in claim 1, further comprising defining in a database a list of allowed status and forbidden status events.

43. A method as claimed in claim 42, wherein the defining step comprises defining what system calls given user mode applications are allowed to place.

44. A method as claimed in claim 1, wherein the performing step comprises one or more of the following: outputting a notification signal whenever a forbidden status event is detected; storing a record of the detected event; blocking the user-initiated event; raising a flag upon detection of a first event and monitoring for a given further user-initiated event, a further action being performed on detection of the given further event.

45. A method as claimed in claim 1, further comprising watching for user-initiated attempts to circumvent data leak protection.

46. A method as claimed in claim 45, further comprising shutting down the computing device when a circumvention attempt is detected or re-booting the computing device when a circumvention attempt is detected.

47. A method as claimed in claim 1, wherein the user-initiated event comprises one or more of the following: a copy/paste event; a file renaming event; a file deletion event; mounting or dismounting a removable device; a printscreen event; a network change event; a console command event, a task scheduler event; a Save As event; a Print event.

48. A method as claimed in claim 39, wherein the determining step comprises checking name and a hash code of a program requiring access to system resources of the computing device.

49. A data leakage protection system for managing user interaction with a computing device, the computing device comprising a kernel mode of operation and a user mode of operation, the method comprising:
monitoring module arranged to monitor the kernel mode of the computing device in order to detect user-initiated events;
determining module arranged to determine whether a given user-initiated event has a forbidden status or an allowed status;
performing module arranged to perform an action in dependence on the status of the given user-initiated event.

50. A computer program embodied on a computer readable medium for controlling a computing device to manage user interaction with the computing device, the computing device comprising a kernel mode of operation and a user mode of operation, wherein the computer program comprises:
a code segment for monitoring the kernel mode of the computing device in order to detect user-initiated events;
a code segment for determining whether a given user-initiated event has a forbidden status or an allowed status;
a code segment for performing an action in dependence on the status of the given user-initiated event.

51. A data leakage protection application for managing user interaction with a computing device, the computing device comprising a kernel mode of operation and a user mode of operation, the method comprising:
monitoring module arranged to monitor the kernel mode of the computing device in order to detect user-initiated events;
determining module arranged to determine whether a given user-initiated event has a forbidden status or an allowed status;
performing module arranged to perform an action in dependence on the status of the given user-initiated event.

52. A network comprising a plurality of computing devices in communication with a server wherein each computing device comprises a data leak protection application according to claim 51.
